(19) United States
(12) Patent Application Publication
(10) Pub. No.: US 2006/0217859 A1
(43) Pub. Date: Sep. 28, 2006

(54) Controlling a vehicle damper and differentiating between wheel and body events

(76) Inventor: David J. Barta, Beavercreek, OH (US)

Correspondence Address: Delphi Technologies, Inc.;M/C 480 -410-202, P.O. Box 5052, Troy, MI, 48007-5052, US

(21) Appl. No.: 11/086,109

(22) Filed: Mar. 22, 2005

(51) Int. Cl. B60G 17/018

(52) U.S. Cl. 701/37; 280/5.5

(57) ABSTRACT

A first method for differentiating between a wheel event and a body event in a control algorithm for a controllable suspension damper for a vehicle wheel. An input signal corresponding to the vertical velocity of the vehicle wheel is obtained. The input signal is filtered to obtain an output signal. The frequency of the input signal is determined using the input and output signals. Another step includes distinguishing between a wheel event and a body event using the determined frequency. A second method for controlling a controllable suspension damper for a vehicle wheel includes the first three steps of the first method. Another step includes applying a vehicle-wheel-event control signal to the controllable suspension damper for at least some determined frequencies greater than a predetermined low value. Another step includes applying no vehicle-wheel-event control signal to the controllable suspension damper if the determined frequency is below the predetermined low value.

### TECHNICAL FIELD

The present invention relates generally to vehicle dampers, and more particularly to a method for controlling a controllable suspension damper for a vehicle wheel and to a method for differentiating between a wheel event and a body event.

### BACKGROUND OF THE INVENTION

Known controllable suspension dampers for a vehicle wheel include magnetorheological suspension dampers and hydraulic-valve suspension dampers. A known method for controlling a magnetorheological (MR) suspension damper for a vehicle wheel includes obtaining the vertical velocity of the vehicle wheel. The vertical velocity of the vehicle wheel is the velocity of the vehicle wheel in a direction substantially perpendicular to the road surface. The known method uses a band-pass filter designed to favor passing vertical velocity signals having a frequency band (typically 10 to 20 Hertz) within the wheel event range (typically 10 Hertz or greater). An example of a wheel event is a wheel hop occurring when a wheel passes in and out of a disturbance in the road. A wheel event is different from a body event which produces a vertical velocity signal typically in the range of 1 to 3 Hertz. An example of a body event is a when the body of the vehicle moves (pitches, heaves, and then pitches again) after it goes up and over a dip in the road. The magnitude of the band-passed filtered signal remains fairly constant over the wheel event frequencies, but the phase of the filtered signal does not. The filtered signal is used in a calibratable look-up table, based on a predetermined wheel control curve, to obtain the MR damper control current, which is always applied to the MR suspension damper.

What is needed is an improved method for controlling a controllable suspension damper for a vehicle wheel event and an improved method for differentiating between a wheel event and a body event.

### SUMMARY OF THE INVENTION

A first method of the invention is for differentiating between a wheel event and a body event in a control algorithm for a controllable suspension damper for a vehicle wheel. The first method includes steps a) through d). Step a) includes obtaining an input signal corresponding to the vertical velocity of the vehicle wheel. Step b) includes filtering the input signal with a filter to obtain an output signal. Step c) includes determining the frequency of the input signal using the input and output signals. Step d) includes distinguishing between a wheel event and a body event using the determined frequency.

A second method of the invention is for controlling a controllable suspension damper for a vehicle wheel. The second method includes steps a) through e). Step a) includes obtaining an input signal corresponding to the vertical velocity of the vehicle wheel. Step b) includes filtering the input signal with a filter to obtain an output signal. Step c) includes determining the frequency of the input signal using the input and output signals. Step d) includes applying a vehicle-wheel-event control signal to the controllable suspension damper for at least some determined frequencies greater than a predetermined low value. Step e) includes applying no vehicle-wheel-event control signal to the controllable suspension damper if the determined frequency is below the predetermined low value, wherein the predetermined low value differentiates between a vehicle wheel event and a vehicle body event.

A third method of the invention is for controlling a magnetorheological suspension damper for a vehicle wheel. The third method includes steps a) through e). Step a) includes obtaining an input signal corresponding to the vertical velocity of the vehicle wheel. Step b) includes filtering the input signal with a lead-lag filter to obtain an output signal. Step c) includes determining the frequency of the input signal using the magnitudes of the input and output signals. Step d) includes applying a vehicle-wheel-event control signal to the magnetorheological suspension damper for at least some determined frequencies greater than a predetermined low value. Step e) includes applying no vehicle-wheel-event control signal to the magnetorheological suspension damper if the determined frequency is below the predetermined low value, wherein the predetermined low value differentiates between a vehicle wheel event and a vehicle body event.

Several benefits and advantages are derived from one or more of the methods of the invention. In one example, applying no vehicle-wheel-event control signal to the controllable damper if the determined frequency is below a predetermined low value (such value differentiating between a vehicle wheel event and a vehicle body event) provides a more consistent ride than using the control method of the prior art. In the same or a different example, using a lead-lag filter gives a more consistent phase response over wheel event frequencies providing a more consistent ride than using the band-pass filter of the prior art.

### SUMMARY OF THE DRAWINGS

FIG. 1 is a schematic block diagram of an example of a control method of the invention; and

FIG. 2 is a schematic block diagram of an example of the logic of a wheel-event differentiating method used in the control method of FIG. 1.

### DETAILED DESCRIPTION

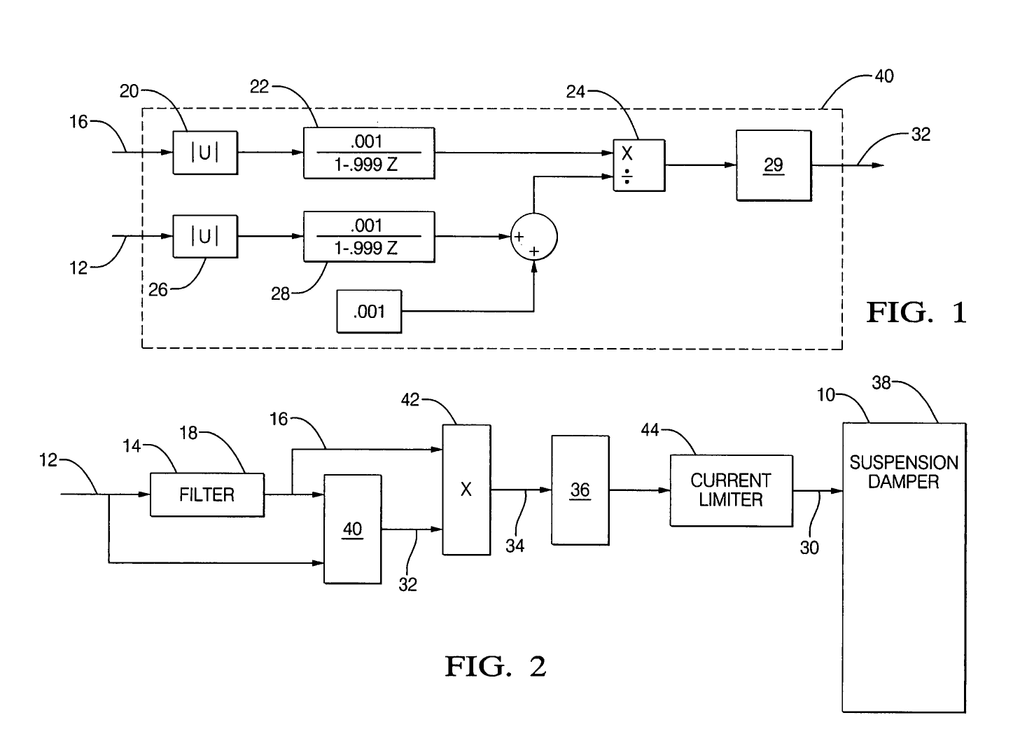

Referring now to FIGS. 1 and 2 of the drawings, a first method of the invention is for differentiating between a wheel event and a body event in a control algorithm for a controllable suspension damper 10 for a vehicle wheel. The first method includes steps a) through d). Step a) includes obtaining an input signal 12 corresponding to the vertical velocity of the vehicle wheel. The vertical velocity of a vehicle wheel is the velocity of the vehicle wheel in a direction substantially perpendicular to the road surface. Step b) includes filtering the input signal 12 with a filter 14 to obtain an output signal 16. Step c) includes determining the frequency of the input signal 12 using the input and output signals 12 and 16. Step d) includes distinguishing between a wheel event and a body event using the determined frequency.

In one construction, the filter 14 is a lead-lag filter 18. In one variation, step c) includes determining the ratio of the magnitude of the output signal 16 to the magnitude of the input signal 12. In one modification, step c) includes using a predetermined (calibratable) look-up table of determined frequencies versus ratios for the filter 14 (such as a lead-lag filter 18). In another construction, not shown, the filter is a band-pass filter, step c) includes determining the phase difference between the output and input signals, and step c) includes using a predetermined look-up table of determined frequencies versus phase differences for the band-pass filter. The use of other filter constructions is left to the artisan.

In one enablement of the first method, as shown in FIG. 1, the output signal 16 from the lead-lag filter 18 enters block 20 where the absolute value of the amplitude is obtained and fed through a low-pass filter 22 (wherein z denotes the discrete transfer function form [z-transform]) to block 24. Input signal 12 enters block 26 where the absolute value of the amplitude is obtained and fed through a low pass filter 28 and summed with the number 0.001 (typical) before entering block 24. Block 24 calculates the amplitude ratio. It is noted that use of absolute values and low-pass filters provides averaging, and that the addition of the number 0.001 (typical) added in the denominator of the ratio insures no division-by-zero problems. The amplitude ratio is matched to a value of the known amplitude versus frequency characteristics of the lead-lag filter 18 to determine the frequency in block 29. Block 29 outputs a scale factor 32 (to be discussed in the second method of the invention). In one example, frequencies below a predetermined low value (e.g., 10 Hertz) defines a body event while frequencies above the predetermined low value defines a wheel event. Other enablements and examples (including other predetermined low values used to distinguish between wheel and body events) are left to the artisan.

A second method of the invention is for controlling a controllable suspension damper 10 for a vehicle wheel. The second method includes steps a) through e). Step a) includes obtaining an input signal 12 corresponding to the vertical velocity of the vehicle wheel. Step b) includes filtering the input signal 12 with a filter 14 to obtain an output signal 16. Step c) includes determining the frequency of the input signal 12 using the input and output signals 12 and 16. Step d) includes applying a vehicle-wheel-event control signal 30 to the controllable suspension damper 10 for at least some determined frequencies greater than a predetermined low value. Step e) includes applying no vehicle-wheel-event control signal to the controllable suspension damper 10 if the determined frequency is below the predetermined low value, wherein the predetermined low value differentiates between a vehicle wheel event and a vehicle body event. It is noted that applying no vehicle-wheel-event control signal is the same as applying a zero vehicle-wheel-event control signal.

In one example of the second method, the predetermined low value corresponds to a predetermined lowest wheel event frequency. In one variation, step d) applies a vehicle-wheel-event control signal 30 to the controllable suspension damper 10 for a range of determined frequencies between the predetermined low value and a predetermined high value, and step e) applies no vehicle-wheel-event control signal to the controllable suspension damper 10 if the determined frequency is above the predetermined high value. In one modification, the predetermined high value corresponds to a predetermined highest wheel event frequency. In one variation, the predetermined low value is 10 Hertz and the predetermined high value is 20 Hertz.

In one application of the second method, step d) includes multiplying the output signal 16 by a scale factor 32 to obtain a scaled output signal 34. In one variation, the scale factor 32 is unity. In a different variation, the scale factor 32 depends on the determined frequency to compensate for frequency-dependent gain changes of the filter 14.

In one implementation of the second method, the vehicle-wheel-event control signal 30 is determined from the scaled output signal 34 and a predetermined wheel control curve (shown as block 36).

In one employment of the second method, the vehicle-wheel-event control signal 30 is an electric current. In one variation, the controllable suspension damper 10 is a magnetorheological damper 38. In a different variation, the controllable suspension damper is a hydraulic-valve suspension damper. Other variations and employments are left to the artisan. In one construction, the filter 14 is a lead-lag filter 18. Other types of filters are left to those skilled in the art.

In one illustration of the second method, the predetermined lowest wheel event frequency corresponds to the natural frequency of the suspension spring (not shown), the controllable suspension damper 10, and the mass of the vehicle wheel (which includes the tire).

In one enablement of the second method, as shown in FIG. 2, the input signal 12 branches, with one branch passing through the filter 14 to yield the output signal 16 and the other branch entering block 40. One branch of the output signal 16 enters block 40. Block 40 is shown in greater detail in FIG. 1. The output of block 40 is the scale factor 32. Block 40 determines the frequency of the input signal 12 from the input and output signals 12 and 16. If the determined frequency indicates a wheel event to be controlled (e.g., a determined frequency between 10 and 20 Hertz), block 40 outputs the scale factor 32 as previously described. If the determined frequency indicates a body event (e.g., below 10 Hz) or a wheel event not to be controlled (e.g., above 20 Hz), block 40 outputs a zero scale factor. Returning to FIG. 2, block 42 multiplies the output signal 16 by the scale factor 32. The scaled output signal 34 enters block 36 to apply a predetermined wheel control curve to output a current which enters current limiter 44 to become the vehicle-wheel-event control signal 30 to the magnetorheological damper 38. Other enablements are left to the artisan.

A third method of the invention is for controlling a magnetorheological suspension damper 38 for a vehicle wheel. The third method includes steps a) through f). Step a) includes obtaining an input signal 12 corresponding to the vertical velocity of the vehicle wheel. Step b) includes filtering the input signal 12 with a lead-lag filter 18 to obtain an output signal 16. Step c) includes determining the frequency of the input signal 12 using the magnitudes of the input and output signals 12 and 16. Step d) includes applying a vehicle-wheel-event control signal 30 to the magnetorheological suspension damper 38 for at least some determined frequencies greater than a predetermined low value. Step e) includes applying no vehicle-wheel-event control signal to the magnetorheological suspension damper 38 if the determined frequency is below the predetermined low value, wherein the predetermined low value differentiates between a vehicle wheel event and a vehicle body event.

Several benefits and advantages are derived from one or more of the methods of the invention. In one example, applying no vehicle-wheel-event control signal to the controllable damper if the determined frequency is below a predetermined low value (such value differentiating between a vehicle wheel event and a vehicle body event) provides a more consistent ride than using the control method of the prior art. In the same or a different example, using a lead-lag filter gives a more consistent phase response over wheel event frequencies providing a more consistent ride than using the band-pass filter of the prior art.

The foregoing description of several methods of the invention has been presented for purposes of illustration. It is not intended to be exhaustive or to limit the invention to the precise steps and forms disclosed, and obviously many modifications and variations are possible in light of the above teaching. It is intended that the scope of the invention be defined by the claims appended hereto.

1. A method for differentiating between a wheel event and a body event in a control algorithm for a controllable suspension damper for a vehicle wheel comprising the steps of:
a) obtaining an input signal corresponding to the vertical velocity of the vehicle wheel;
b) filtering the input signal with a filter to obtain an output signal;
c) determining the frequency of the input signal using the input and output signals; and
d) distinguishing between a wheel event and a body event using the determined frequency.

2. The method of claim 1, wherein the filter is a lead-lag filter.

3. The method of claim 2, wherein step c) includes determining the ratio of the magnitude of the output signal to the magnitude of the input signal.

4. The method of claim 3, wherein step c) includes using a predetermined look-up table of determined frequencies versus ratios for the filter.

5. The method of claim 1, wherein step c) includes determining the ratio of the magnitude of the output signal to the magnitude of the input signal.

6. The method of claim 5, wherein step c) includes using a predetermined look-up table of determined frequencies versus ratios for the filter.

7. A method for controlling a controllable suspension damper for a vehicle wheel comprising the steps of:
a) obtaining an input signal corresponding to the vertical velocity of the vehicle wheel;
b) filtering the input signal with a filter to obtain an output signal;
c) determining the frequency of the input signal using the input and output signals;
d) applying a vehicle-wheel-event control signal to the controllable suspension damper for at least some determined frequencies greater than a predetermined low value; and
e) applying no vehicle-wheel-event control signal to the controllable suspension damper if the determined frequency is below the predetermined low value, wherein the predetermined low value differentiates between a vehicle wheel event and a vehicle body event.

8. The method of claim 7, wherein the predetermined low value corresponds to a predetermined lowest wheel event frequency.

9. The method of claim 8, wherein step d) applies a vehicle-wheel-event control signal to the controllable suspension damper for a range of determined frequencies between the predetermined low value and a predetermined high value, and wherein step e) applies no vehicle-wheel-event control signal to the controllable suspension damper if the determined frequency is above the predetermined high value.

10. The method of claim 9, wherein the predetermined high value corresponds to a predetermined highest wheel event frequency.

11. The method of claim 10, wherein step d) includes multiplying the output signal by a scale factor to obtain a scaled output signal.

12. The method of claim 11, wherein the scale factor is unity.

13. The method of claim 11, wherein the scale factor depends on the determined frequency to compensate for frequency-dependent gain changes of the filter.

14. The method of claim 10, wherein the vehicle-wheel-event control signal is determined from the scaled output signal and a predetermined wheel control curve.

15. The method of claim 14, wherein the vehicle-wheel-event control signal is an electric current.

16. The method of claim 15, wherein the controllable suspension damper is a magnetorheological damper.

17. The method of claim 14, wherein the predetermined lowest wheel event frequency corresponds to the natural frequency of the suspension spring, the controllable suspension damper, and the mass of the vehicle wheel.

18. The method of claim 17, wherein the predetermined low value is 10 Hertz and the predetermined high value is 20 Hertz.

19. The method of claim 14, wherein the filter is a lead-lag filter.

20. A method for controlling a magnetorheological suspension damper for a vehicle wheel comprising the steps of:
a) obtaining an input signal corresponding to the vertical velocity of the vehicle wheel;
b) filtering the input signal with a lead-lag filter to obtain an output signal;
c) determining the frequency of the input signal using the magnitudes of the input and output signals;
d) applying a vehicle-wheel-event control signal to the magnetorheological suspension damper for at least some determined frequencies greater than a predetermined low value; and
e) applying no vehicle-wheel-event control signal to the magnetorheological suspension damper if the determined frequency is below the predetermined low value, wherein the predetermined low value differentiates between a vehicle wheel event and a vehicle body event.
